(19) United States
(12) Patent Application Publication
(10) Pub. No.: US 2002/0091578 A1
(43) Pub. Date: Jul. 11, 2002

(54) Electronic commerce card and methods for using and distributing electronic commerce cards

(76) Inventor: Jason Thomas, Hillsboro, OH (US)

Correspondence Address: DINSMORE & SHOHL, LLP, 1900 CHEMED CENTER, 255 EAST FIFTH STREET, CINCINNATI, OH, 45202, US

(21) Appl. No.: 09/756,413

(22) Filed: Jan. 8, 2001

(51) Int. Cl. G06F 17/60

(52) U.S. Cl. 705/26; 705/27

(57) ABSTRACT

An electronic commerce card together with methods for using and distributing commerce cards are provided. A fixed non-renewable amount of currency associated with a remote account is provided, and it is operable to be debited and transferred to a second remote account. Further, a unique identification key operable to identify the remote account and be used to electronically purchase goods and services is provided. Moreover, a method of distributing electronic commerce cards is provided where a key is associated with a fixed non-renewable amount of currency. Furthermore, the key is provided to a merchant and distributed to a consumer. Also, a method of using electronic commerce cards is provided wherein a key is acquired and associated with a fixed non-renewable amount of currency, and the key is used to purchase goods or services.

### FIELD OF THE INVENTION

The present invention relates to providing an electronic commerce card and methods for using and distributing electronic commerce cards.

### BACKGROUND OF THE INVENTION

Electronic transactions are omnipresent today with the advent of the Internet and the World Wide Web (WWW). These electronic transactions are increasing annually at phenomenal growth rates. Further, these transactions are primarily transacted with the use of credit cards or debit cards issued by large institutions. In a typical transaction, a consumer utilizing a browser, which is operable to interface with an Internet connection and to interface with the WWW, will input via a web page a variety of information, including a credit card number.

Some of the information which a consumer enters on a web page during an electronic commerce transaction, is believed to be private and personal by the consumer, such as by way of example only, consumer name, consumer credit card number, and others. In some instances, this private information used by a consumer has been used by vendors to collect more personal information about the consumer, such as by way of example only, the consumer's home address, the consumer's home phone number, and others. Vendors then use this information in an attempt to further solicit the consumer for additional offers, these additional offers may be presented to the consumers through a variety of channels, such as by way of example only, junk electronic mail, junk postal pail, telemarketing phone calls, and others.

Many consumers are extremely reluctant to provide any personal information during an electronic transaction as a result of this loss of privacy and perceived intrusion into the personal lives of the consumers. As a result, a large number of consumers connected to the Internet and the WWW have not participated in the electronic commerce revolution currently taking place throughout the world.

Recently, consumer apprehensions associated with the Internet have been confirmed with the discovery of large criminal schemes by government authorities, wherein credit card numbers were intercepted and stolen over the Internet, with the consumers being charged for services and items never purchased.

Furthermore, a very large segment of consumers desire anonymity while traversing the Internet or the WWW. Yet, many web sites offering free trials to consumers require the consumer to input a credit card number. Some of these web sties may include, by way of example only, sites which society has viewed as a vice, although not illegal, such as by way of example only, adult entertainment, and legal gamming sites. Correspondingly, consumers are extremely reluctant to provide credit card numbers or electronic mail addresses to these sites, because doing so almost surely will subject the consumer to some form of advertising related to these activities which the consumer desires to keep private.

In response to this privacy issue, a few organizations have attempted to provide consumers with credit cards which are disposable, debit cards, smart cards were money may be depleted and replenished on the card itself, on-line gift currency or loyalty points, and the like. The problem with all of these types of cards and currencies are that each of them are associated directly with the consumer, and the corresponding consumer agreements, which a consumer agrees to abide by when enrolling in one of these programs, permit the issuer of the cards and the currencies to release consumer information to marketers. Moreover, if information is not released to marketers, the issuer of the card and the currency is still aware of all the card activities of the consumer.

Furthermore, on-line gift currency and loyalty points are often associated with expiration dates, which requires the consumer to use the currency or points within a predefined amount of time or the value of the currency or the points become worthless. Also, the use of online gift currency and loyalty points are largely circumscribed to vendors with a predefined relationship with the issuers of the currency and points. Accordingly, consumers are restricted to participating merchants when using these currencies and points.

Accordingly, a form of electronic currency needs to be made available where the consumer's anonymity is preserved and ensured. Also, the electronic currency needs to be similar to cash, so that it is readily accepted anywhere on the Internet, WWW, or at normal brick and mortar establishments. Further, acquisition of the electronic currency should be easily acquired by a consumer, either electronically, or through brick and mortar establishments, or any other channel.

### SUMMARY OF THE INVENTION

Accordingly, it is an object of the present invention to provide a novel electronic commerce card. Moreover, methods of using and distributing electronic commerce cards of the present invention are provided. An electronic commerce card has a unique tag associated therewith, such that when the tag is accessed a fixed non-renewable amount of currency is available to be transferred to a second vendor account.

Further, the fixed non-renewable amount of currency is debited by the amount transferred to the second vendor account. Although as one skilled in the art will readily appreciate, the amount actually deposited in the vendor account may be less than what is debited from the currency associated with the commerce card tag. In this way, the issuer of the electronic commerce card may retain a transactional fee.

Moreover, vendors may distribute electronic commerce cards of the present invention through a variety of channels. For example, a consumer desiring to acquire a $10 electronic commerce card may acquire the tag associated with the fixed non-renewable amount of currency on a plastic card, a plastic card with computer readable medium contained thereon, a sales receipt, an electronic email, via a phone conversation, through interactions with a WWW site, a kiosk, and like. Further, once acquired the electronic commerce card is not traceable to the consumer, and it may be used as if it were cash currency via the Internet, WWW, telephonically, any computing device, interactive television, web television, traditional brick and mortar establishments, via regular postal mail, and the like.

One aspect of the present invention is an electronic commerce card. The card comprises a fixed non-renewable amount of currency associated with a remote account and operable to be debited and transferred to a second remote account. Further, a unique identification key operable to identify the remote account is provided for purposes of electronically purchasing goods or services.

Further, a method of distributing electronic cards is provided, comprising associating a key with a fixed non-renewable amount of currency. The key is provided to a merchant and distributed to a consumer, where it may be used to purchase electronic goods or services.

Moreover, a method of using electronic cards is provided, comprising acquiring a key associated with a fixed non-renewable amount of currency and using the key to purchase goods or services.

Still other aspects of the present invention will become apparent to those skilled in the art from the following description of an exemplary embodiment, which is by way of illustration, one of the best modes contemplated for carrying out the invention. As will be realized, the invention is capable of other different and obvious aspects, all without departing from the invention. Accordingly, the drawings and descriptions are illustrative in nature and not restrictive.

### BRIEF DESCRIPTION OF THE DRAWINGS

The accompanying drawings, incorporated in and forming part of the specification, illustrate several aspects of the present invention and, together with their descriptions, serve to explain the principles of the invention. In the drawings:

FIG. 1 depicts a front view of an electronic commerce card;

FIG. 2 depicts a back view of an electronic commerce card;

FIG. 3 depicts an electronic commerce card printed on a sales receipt

FIG. 4 depicts an electronic commerce card provided in an electronic mail;

FIG. 5 depicts a method for distributing electronic commerce cards; and

FIG. 6 depicts a method of using electronic commerce cards.

### DETAILED DESCRIPTION

The present invention provides an electronic commerce card as well as methods for distributing and using electronic commerce cards. These cards may be used by a consumer anonymously in the purchasing of goods and services over the Internet, WWW, brick and mortar establishments, kiosks, and through a variety of other electronic media. Further, these cards may be used in place of a credit card or a gift card.

One embodiment of the present invention is implemented using web browser technologies including well-known software programming languages (e.g., C, C++, Java, JavaBeans, ActiveX, Active Server Pages) and Internet communication protocols (TCP/IP). Moreover, data formatting languages are used such as XML, HTML, and XSLT. Of course other programming languages, communications protocols, and data formatting languages (now known or hereafter developed) may be also readily employed. These technologies are used in well known electronic transactions where unique tags are transferred and associated with accounts associated with a consumer. However, all prior techniques resolve the identity of the consumer during the transaction, which thereby destroys any consumer desired anonymity.

Further, production of tangible cards, such as phone cards, used solely for the purpose of acquiring long distance telephone usage, is well known in the industry and may be readily deployed by one skilled in the art to produce a tangible electronic commerce card, made of material, such as by way of example only, plastic. These cards may then be acquired by consumers at brick and mortar stores, through kiosks, via WWW transactions, via Internet transactions, via regular postal mail, and other channels.

Yet, as one skilled in the art will readily appreciate no tangible card may be needed at all to distribute electronic commerce cards to consumers. Since, large blocks of unique tags associated with non-renewable fixed amounts of currency through a single bank account may be distributed to vendors electronically. In this way, a consumer could purchase an electronic commerce card, by way of example only, at the grocery store from a cashier, and the unique tag along with the associated non-renewable amount of currency may be printed on the customer's sales receipt. Further, a kiosk machine similar to a lottery kiosk may dispense printed receipts with unique tags and fixed non-renewable currency amounts printed thereon.

Moreover, the electronic commerce card is similar to an electronic airline ticket in that it may or may not be on any tangible medium. For example, the electronic commerce card may be received by a consumer during a phone conversation with a vendor, sent to a consumer's electronic mail account, acquired off of a web page, and the like.

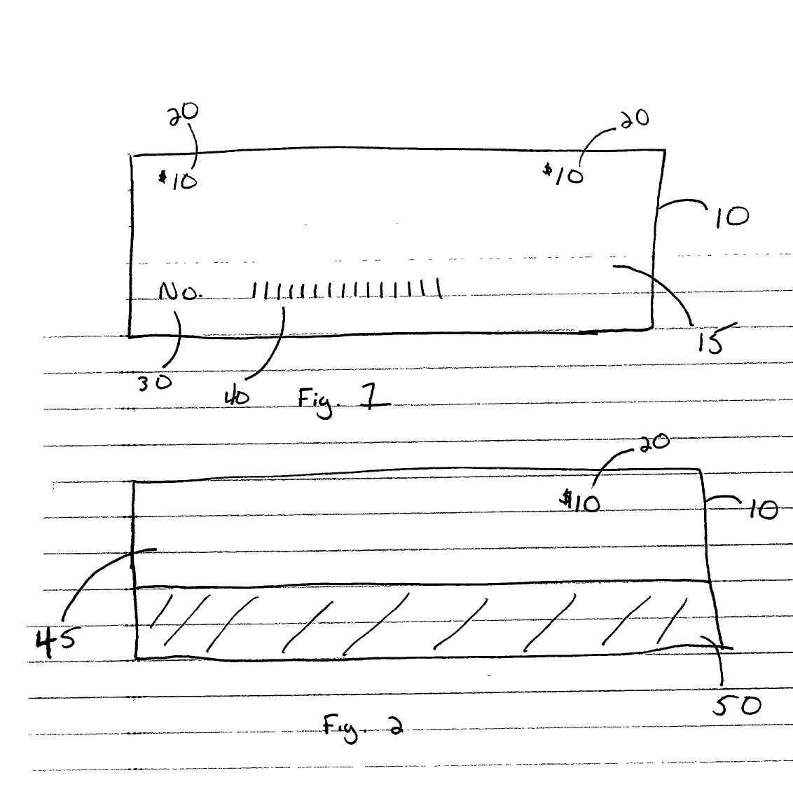

FIG. 1 displays the front side 15 of a tangible electronic commerce card 10 of the present invention. This electronic commerce card may be made of any material, such as paper, plastic, and others. The construction of card 10 would be readily apparent to those skilled in the art. A label such as “No.” 30 displayed on the front 15 of the card 10 indicates that the unique tag “111111111111111” 40 is what identifies this particular electronic commerce card 10, and its corresponding fixed non-renewable, but depletable, currency amount $10 20.

FIG. 2 displays the rear side 45 of a tangible electronic commerce card 10. Optionally, a computer readable medium, such as by way of example only, magnetic strip 50, may be affixed to the rear side 45 of the electronic commerce card 10. This magnetic strip 50 may include the unique tag 40, displayed on the front side 15 of the card 10.

In this way, the card 10 may be swiped through a standard card reading device, such as by way of example only, a credit card point of sale (POS) device, located in most brick and mortar vendor establishments. Once the card is swiped, an electronic communication connection is made to the bank account associated with unique tag 40 with a sub account readily identified by the unique tag 40 and associated with a fixed non-renewable currency amount, such as $10 20. This permits a consumer to use the electronic commerce card 10 as he/she would use a typical credit/debit card. However, the POS transaction cannot identify the consumer's identity. Moreover, the consumer may not renew the card 10, any fractional amount of currency remaining in the account associated with the unique tag 40 may be used to purchase another card, or redeemed for cash with a vendor, kiosk, and the like.

FIG. 3 depicts an electronic commerce card which is imprinted on a sales receipt 60. As previously present the exact embodiment of the electronic commerce card may take on a variety of forms. In FIG. 3 a fixed non-renewable dollar amount of $10 80 is identified on the sales receipt 60. Any other items 70 purchased by the customer will display normally on the sales receipt 60 with the electronic commerce card. Although, as one skilled in the art will readily appreciate, the electronic card may be printed on a sales receipt by itself and need not appear with other purchased items by the customer. Further, a unique tag “111111111111111” 90 provides a unique number which when used by a customer will provide electronic access to an account having exactly $10 100.

In this way, a customer at a traditional brick and mortar store, may purchase an electronic commerce card in various denominations or amounts and have that commerce card imprinted on a sales receipt. Moreover, the receipt may come for a kiosk (e.g., similar to a lottery kiosk). Additionally, the receipt with an electronic commerce card imprinted thereon could be received by facsimile, after a transaction by the customer to purchase the electronic commerce card occurred via a telephone, Internet, WWW, computing device, and the like.

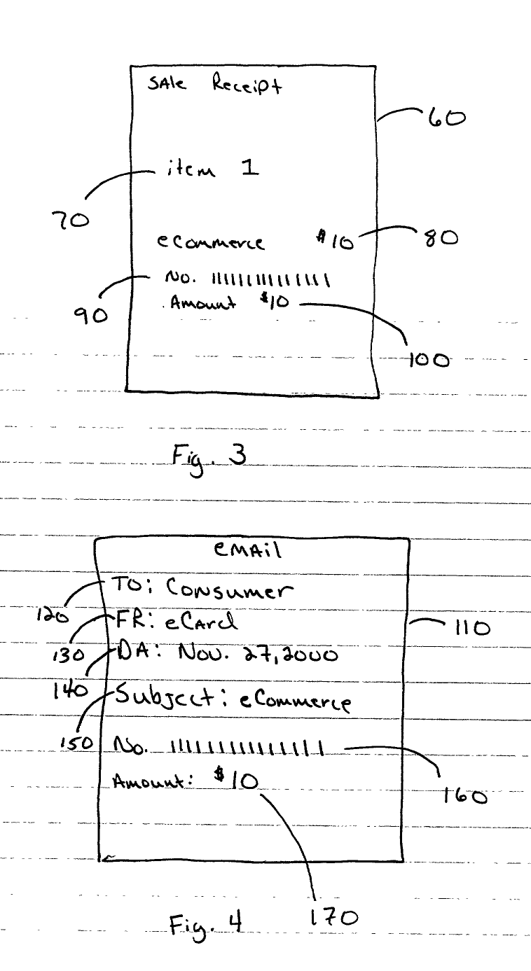

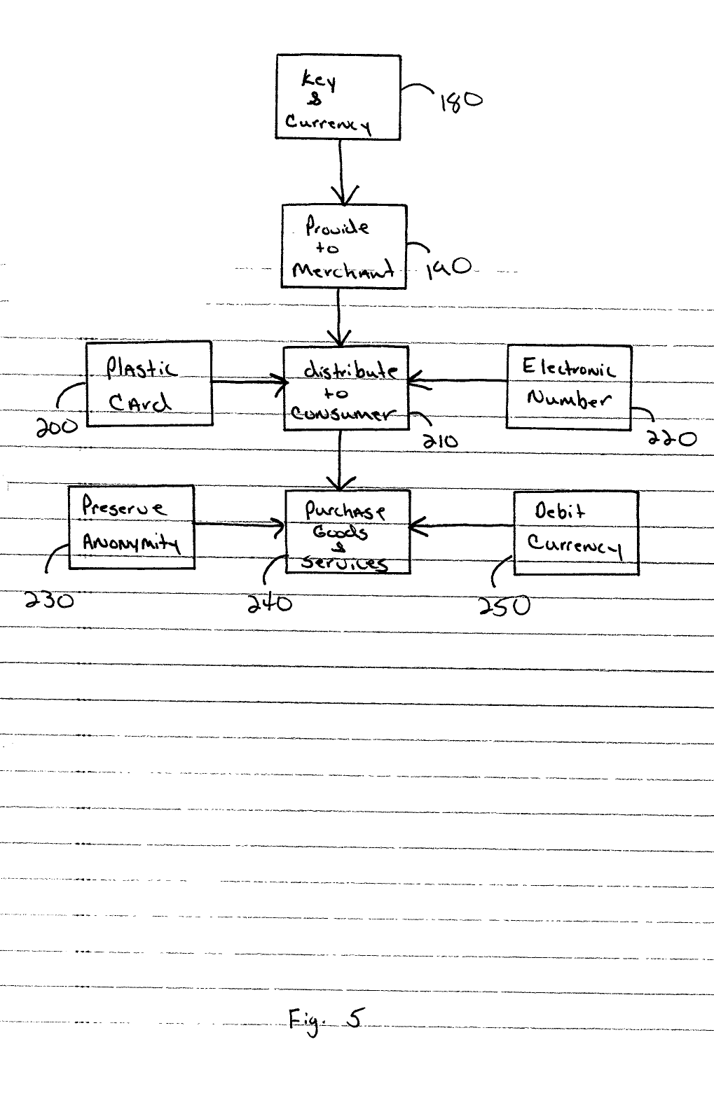

FIG. 4 depicts an electronic mail message 110 wherein an electronic commerce card resides and is discernable by a unique tag “111111111111111” 160 and a fixed non-renewable amount of currency $10 170. Optionally, the subject line 150 of the message 110 may describe what the content of the message 110 is regarding, such as “eCommerce.” The message may be electronically sent to the consumer 120 from a merchant 130 providing the electronic commerce card.

As one skilled in the art will readily appreciate, an electronic commerce card of the present invention may be embodied in a variety of media. In this way, the electronic commerce card may be acquired and used by the consumer in a variety of ways with a fixed non-renewable amount of currency available to the consumer to use without the need to disclose information considered to be private by the consumer.

Moreover, since the electronic commerce card is currency and not credit, the use of the commerce card may be permissibly used by a consumer in purchasing a lottery ticket. Most lottery commissions within the fifty states of the United States have enacted laws which forbid the use of credit when purchasing lottery tickets. Yet, since the electronic commerce card is currency, which is non-renewable and paid for in advance by the consumer, there should be no apparent impediment in allowing the consumer to purchase lottery tickets using an electronic commerce card of the present invention. Further, this would permit consumers to purchase lottery tickets over the Internet using web browsers and the like. Also, consumers could purchase lottery tickets from all over the fifty states from a single location.

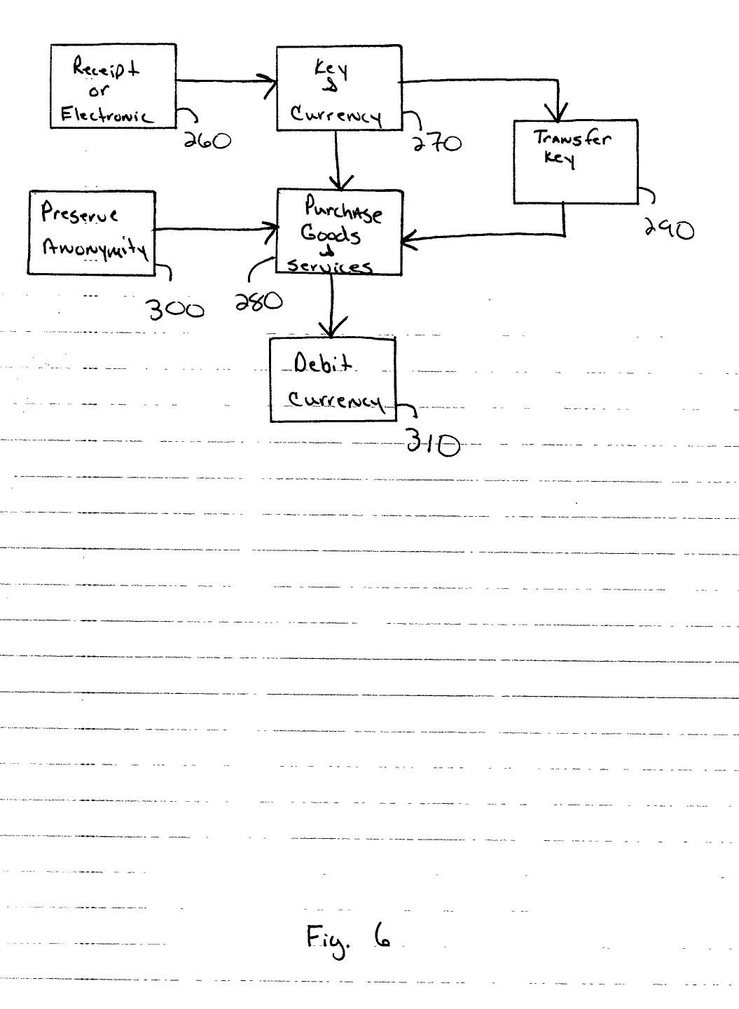

FIG. 5 depicts a method for distributing electronic commerce cards. Initially, a single financial account may be set up comprising multiple sub accounts, each sub account having a key which is operable to electronically identify a specified sub account. Furthermore, each sub account is associated with a fixed non-renewable amount of currency. In this way, a key and a fixed amount of currency may be associated with one another and provided in step 180.

Moreover, the key may be made available to a merchant in step 190. The merchant may then distribute the key to a consumer in step 210. As previously presented the merchant may distribute the electronic commerce card to the consumer in a variety of media such as, an electronic number in step 220 via email, the Internet, facsimile, and the like. Further, the card may be distributed as a plastic card, much like a credit card in step 200.

The consumer may then use the key to purchase goods and services in step 240. Further, when a purchase occurs an amount of the currency associated with the electronic commerce card equivalent to the price of the good or service purchased will be debited in step 250 from the account associated with the electronic commerce card. Debits will deplete the account associated with the electronic commerce card, yet the account may not be replenished. In fact, once the account is completely depleted, the account is no longer valid, but rather, it is terminated or closed. Although, as one skilled in the art will readily appreciate the keys associated with these terminated accounts may be recycled and used anew by an issuer of the electronic commerce cards.

Additionally, when a consumer makes a purchase of a good or a service, the anonymity of the consumer is preserved in step 230. This is so, because there is no information associated with the electronic commerce card beyond the key and a fixed non-renewable amount of currency which is depletable, but not renewable.

Anonymity permits the consumer to acquire goods and services without the apprehension of receiving unwanted marketing information, especially when the consumer desires to purchase goods or services associated with adult entertainment, health related goods or services, and the like.

FIG. 6 depicts a method of using electronic commerce cards. Initially, a key and a fixed amount of non-renewable currency are acquired. As previously presented, acquisition of the key in step 270 may occur through a variety of media in step 260 (e.g., embodied as a plastic card purchased at a merchant's place of business, embodied on a sales receipt from a merchant, received as an electronic mail message, and others).

Further, merchants may receive electronically the key in the place of credit card numbers, such as by way of example only, a merchant web site providing online purchases of goods and services where the site requires a credit card number to complete an electronic transaction. In this way, the key associated with the electronic commerce card may be transferred to a merchant in step 290, in a manner similar to the transferring of credit card identification information. Moreover, the key is used to access an account which permits a consumer to purchase goods and services in step 280 as if the consumer was using cash.

During the electronic transaction, information associated with the consumer is not available to the merchant or to the issuer of the electronic commerce card. In this way, the anonymity of the consumer is preserved in step 300. Further, once a good or service is successfully purchased by the consumer, an amount of currency associated with a price of the good or service purchased is debited from an account associated with the electronic commerce card in step 310. Although the account associated with the electronic commerce card may be depleted it may not be renewed as previously presented.

The foregoing description of the preferred embodiment of the invention has been presented for purposes of illustration and description. It is not intended to be exhaustive nor to limit the invention to the precise form disclosed. Many alternatives, modifications, and variations will be apparent to those skilled in the art in light of the above teaching. Accordingly, this invention is intended to embrace all alternatives, modifications, and variations that fall within the spirit and broad scope of the attached claims.

What is claimed is:

1. An electronic commerce card, comprising:
a fixed non-renewable amount of currency associated with a remote account operable to be debited and operable to be transferred to a second remote account; and
a unique identification key operable to identify the remote account and be used electronically to purchase goods or services.

2. The card of claim 1, further comprising:
a computer readable strip on the card operable to communicate the identification key.

3. The card of claim 1, wherein the identification key is provided in place of a credit card number for an electronic transaction.

4. The card of claim 1, wherein the identification key is not traceable to a user of the card.

5. The card of claim 1, wherein the key may be provided anonymously by a user to acquire one or more of the goods or services.

6. The card of claim 1, wherein the card is acquired for a price equal to or greater than the fixed non-renewable amount of currency.

7. The card of claim 1, wherein the key is operable to be distributed to a user on a receipt.

8. The card of claim 1, wherein the key is operable to be distributed to a user via an electronic email.

9. A method of distributing electronic cards, having executable instructions, comprising
associating a key with a fixed non-renewable amount of currency;
providing the key to a merchant; and
distributing the key to a consumer.

10. The method of claim 9, wherein the key is provided to the merchant on a plastic card.

11. The method of claim 9, wherein the key is provided as a number electronically delivered to the merchant.

12. The method of claim 9, further comprising:
using the key by the consumer to purchase goods or services.

13. The method of claim 12, wherein the key is used via the Internet in an electronic transaction.

14. The method of claim 13, wherein the electronic transaction occurs with anonymity of the consumer.

15. The method of claim 9, further comprising:
debiting the currency when the key is used by the consumer to purchase goods or services.

16. A method of using electronic cards, having executable instructions, comprising:
acquiring a key associated with a fixed non-renewable amount of currency; and
using the key to purchase goods or services.

17. The method of 16, further comprising:
transferring the key electronically to a merchant instead of a credit card number.

18. The method of claim 16, further comprising:
preserving the anonymity of a consumer using the key to purchase the goods or services.

19. The method of claim 16, wherein the key is acquired on a receipt by a consumer.

20. The method of claim 16, wherein the key is acquired electronically by a consumer.
